(19) United States
(12) Patent Application Publication
(10) Pub. No.: US 2026/0225599 A1
(43) Pub. Date: Aug. 6, 2026

(54) SYSTEM AND METHOD FOR EMERGENT SCENARIO DETECTION DURING NON-DRIVING SITUATIONS IN AN AUTOMOTIVE VEHICLE

(71) Applicant: GM GLOBAL TECHNOLOGY OPERATIONS LLC, Detroit, MI (US)

(72) Inventors: Gaurav Talwar, Novi, MI (US); Prabhjot Kaur, Portland, OR (US); Russell A. Patenaude, Macomb Township, MI (US); Kenneth R. Booker, Grosse Pointe Woods, MI (US)

(73) Assignee: GM GLOBAL TECHNOLOGY OPERATIONS LLC, Detroit, MI (US)

(21) Appl. No.: 19/045,792

(22) Filed: Feb. 5, 2025

(51) Int. Cl. B60W 50/00; B60W 40/08; G06F 40/20

(52) U.S. Cl. CPC B60W 50/0098; B60W 40/08; G06F 40/20; B60W 2040/0809; B60W 2040/0881; B60W 2420/403; B60W 2420/54; B60W 2540/21; B60W 2540/229; B60W 2555/20; B60W 2556/10; B60W 2556/45

(57) ABSTRACT

A system and method of emergent scenario detection during non-driving situations in an automotive vehicle that is capable of transporting one or more human occupants are presented, in which one or more sensors onboard the vehicle and a large language model are used to detect and triage potential distress situations. A method for training the large language model is also provided.

### INTRODUCTION

This disclosure relates generally to systems and methods for emergent scenario detection during non-driving situations in an automotive vehicle.

Some modern automotive vehicles include a system onboard the vehicle which a driver or occupant may use for calling a central dispatch system from the vehicle for assistance, such as OnStar®. However, there is a case to be made for proactively utilizing such a system, along with other available sensors and systems onboard the vehicle, for detecting certain scenarios or situations where assistance may be needed, as well as having the system automatically place the driver or occupant in contact with such assistance, and for a process of managing or triaging such contacts.

### SUMMARY

According to one embodiment, a method of emergent scenario detection during non-driving situations in an automotive vehicle that is capable of transporting one or more human occupants includes: (i) receiving sensor output from one or more sensors located onboard the automotive vehicle; (ii) detecting a potential distress situation based on the sensor output by using a large language model (LLM), wherein the LLM is trained to identify potential distress situations based on a collection of previously recorded in-vehicle distress calls; (iii) triaging the potential distress situation as being one of an emergent situation, a normal non-emergent situation, a good Samaritan situation and a roadside assistance situation; (iv) for the emergent situation, further triaging the emergent situation as being one or more of a health-related situation, a law enforcement situation, a fire situation and a rescue situation; and (v) for the emergent situation, contacting a respective one or more of an emergency medical service, a law enforcement service, a firefighting service and a rescue service.

The non-driving situations may include the one or more human occupants engaging in one or more of approaching the automotive vehicle, ingressing the automotive vehicle, being seated within but not driving the automotive vehicle, egressing the automotive vehicle, and departing away from the automotive vehicle.

For the emergent situation, the method may further include connecting the one or more human occupants with a live call center; for any of the normal non-emergent situation, the good Samaritan situation and the roadside assistance situation, the method may further include connecting the one or more human occupants with an interactive digital assistant.

The good Samaritan situation may include the one or more human occupants showing awareness of a situation or condition which presents a potential or actual need for assistance relating to a person, an animal, an infrastructure or a property located outside the automotive vehicle.

The roadside assistance situation may include the one or more human occupants showing awareness of a situation or condition which presents a potential or actual need for assistance relating to the automotive vehicle.

The one or more sensors may include one or more of an internal microphone inside the automotive vehicle, an external microphone outside the automotive vehicle, an internal camera inside the automotive vehicle, an external camera outside the automotive vehicle, a seat occupancy detector, a seatbelt payout detector, a PRNDL status detector, a door locked/unlocked status detector, an accessory mode on/off status detector, a key fob/key pass proximity detector, a temperature detector outside the automotive vehicle, a weather sensor outside the automotive vehicle and a wireless receiver of transmitted information. The transmitted information may include information relating to one or more of a location of the automotive vehicle, a current time of day, current or expected weather conditions at the location of the automotive vehicle, and a respective age, medical condition, mobility status or biometric information of one or more of the human occupants.

The method may further include one or more of: (i) detecting a proximity of the one or more human occupants to the automotive vehicle by one or more of receiving a proximity signal from a key fob or a digital device, imaging the one or more human occupants by using a camera onboard the automotive vehicle, and sensing the one or more human occupants by using a microphone onboard the automotive vehicle; and (ii) activating one or more other sensors onboard the automotive vehicle.

The LLM may be trained to identify the potential distress situations by: (a) extracting metadata from the collection of previously recorded in-vehicle distress calls while ignoring personally identifiable information from the distress calls, wherein the metadata include one or more of audio data, text data, sensor data collected by the automotive vehicle or by other automotive vehicles, a type of emergency related to the distress call, and an outcome of the distress call; (b) correlating the metadata to produce a ruleset, wherein for each of the distress calls the ruleset correlates one or more of the audio data, the text data and the sensor data with one or both of the type of emergency and the outcome; and (c) updating the ruleset by repeating the accessing, extracting and correlating steps using additional recorded in-vehicle distress calls.

One or both of the triaging and the further triaging may be performed by using the LLM.

According to another embodiment, a method of training a large language model for use in emergent scenario detection during non-driving situations in an automotive vehicle that is capable of transporting one or more human occupants includes: (i) accessing a collection of previously recorded in-vehicle distress calls; (ii) extracting metadata from the distress calls while ignoring personally identifiable information from the distress calls, wherein the metadata include one or more of audio data, text data, sensor data collected by the automotive vehicle or by other automotive vehicles, a type of emergency related to the distress call, and an outcome of the distress call; (iii) correlating the metadata to produce a ruleset, wherein for each of the distress calls the ruleset correlates one or more of the audio data, the text data and the sensor data with one or both of the type of emergency and the outcome; and (iv) updating the ruleset by repeating the accessing, extracting and correlating steps using additional recorded in-vehicle distress calls.

The method may further include filtering the previously recorded in-vehicle distress calls and the additional recorded in-vehicle distress calls to exclude any driving situations.

The previously recorded in-vehicle distress calls and the additional recorded in-vehicle distress calls may be recorded in one or both of an audio-based format and a text-based format. The method may further include converting any audio-based format of the previously recorded in-vehicle distress calls and the additional recorded in-vehicle distress calls into the text-based format.

The personally identifiable information may include biometric information.

The sensor data may include one or more of: (i) detection data, measurement data, image data or video data received from one or more sensors that are onboard the automotive vehicle; and (ii) transmitted information received from a wireless receiver onboard the automotive vehicle.

The audio data may include one or more of verbal speech sounds, non-verbal speech sounds and non-speech sounds.

The type of emergency may include one or more of an emergent situation, a normal non-emergent situation, a good Samaritan situation and a roadside assistance situation. For the emergent situation, the type of emergency may further include one or more of a health-related situation, a law enforcement situation, a fire situation and a rescue situation, and the outcome may include connecting the one or more human occupants with one or more of a live call center, an emergency medical service, a law enforcement service, a firefighting service and a rescue service.

According to yet another embodiment, a system for emergent scenario detection during non-driving situations in an automotive vehicle that is capable of transporting one or more human occupants includes: (i) one or more sensors onboard the automotive vehicle; (ii) a wireless transceiver onboard the automotive vehicle; (iii) an access point for providing access to a large language model (LLM), wherein the LLM is trained to identify potential distress situations based on a collection of previously recorded in-vehicle distress calls; and (iv) a processor operatively connected with the one or more sensors, the wireless transceiver and the access point. The processor is configured for: (a) receiving sensor output from the one or more sensors; (b) detecting a potential distress situation based on the sensor output by using the LLM; (c) triaging the potential distress situation as being one of an emergent situation, a normal non-emergent situation, a good Samaritan situation and a roadside assistance situation by using the LLM; (d) for the emergent situation, further triaging the emergent situation as being one or more of a health-related situation, a law enforcement situation, a fire situation and a rescue situation by using the LLM; (e) for the emergent situation, contacting a live call center or a respective one or more of an emergency medical service, a law enforcement service, a firefighting service and a rescue service by using the wireless transceiver; and (f) for any of the normal non-emergent situation, the good Samaritan situation and the roadside assistance situation, connecting the one or more human occupants with an interactive digital assistant.

The above features and advantages, and other features and advantages, of the present teachings are readily apparent from the following detailed description of some of the best modes and other embodiments for carrying out the present teachings, as defined in the appended claims, when taken in connection with the accompanying drawings.

### BRIEF DESCRIPTION OF THE DRAWINGS

FIG. 1 is a schematic diagram of an automotive vehicle having a system for emergent scenario detection during non-driving situations.

FIG. 2 is a block diagram of various types of sensors that may be associated with the vehicle of FIG. 1.

FIG. 3 is a block diagram of the system shown in FIG. 1, with further details added regarding the large language model portion of the system.

FIG. 4 is a block diagram illustrating various non-driving situations.

FIG. 5 is a block diagram illustrating various types of situations and corresponding actions taken.

FIG. 6 is a block diagram illustrating various good Samaritan situations.

FIG. 7 is a flowchart for a method of emergent scenario detection during non-driving situations in an automotive vehicle.

FIG. 8 is a flow chart for a method of training a large language model for use in emergent scenario detection during non-driving situations in an automotive vehicle.

FIG. 9 is a block diagram illustrating various types of metadata extracted from a collection of distress calls.

### DETAILED DESCRIPTION

Referring now to the drawings, wherein like numerals indicate like parts in the several views, a system 40 and method 100 for emergent scenario detection during non-driving situations 42 in an automotive vehicle 10, and a method 200 of training a large language model (LLM) 41 for use in emergent scenario detection during non-driving situations 42 in an automotive vehicle 10, are shown and described herein.

The system 40 and methods 100, 200 presented herein may be used to proactively and automatically detect a wide variety of potential distress situations 49 by utilizing existing sensors 15 and sub-systems onboard the vehicle 10. The system 40 and methods 100, 200 may also be used to manage, prioritize or triage such potential distress situations 49 utilizing a two-level classification approach, and to place the vehicle's occupants in contact with either an interactive digital assistant 64 or a live call center 59 (such as OnStar®) for assistance, depending on the type and severity of the detected situation 49.

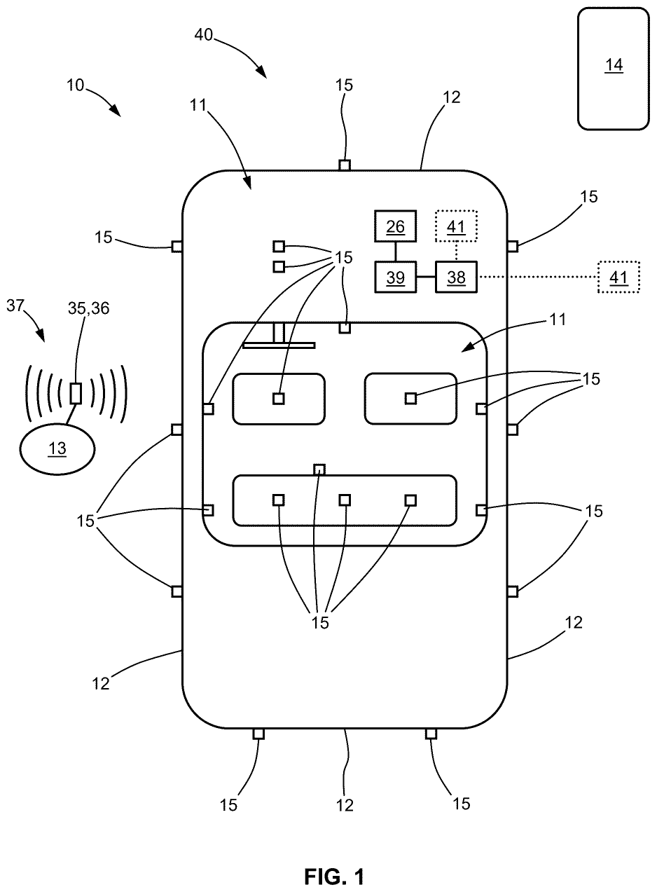

FIG. 1 shows a schematic top view of an automotive vehicle 10 having an interior 11 inside the vehicle 10 and an exterior 12 on the outside of the vehicle 10. For example, the exterior 12 may be the outer, external overall surface of the vehicle 10, and the interior 11 may include the volume of space that is enclosed within the outer surface/exterior 12, such as the cockpit, cabin, engine bay, trunk, wheels wells, etc. and any systems, sub-systems and components therewithin. As shown in the drawing, a human occupant 13 and another automotive vehicle 14 are present outside the vehicle 10. (Note that the other vehicle 14, which is purposely not drawn to scale in FIG. 1, is included here to represent any number of other vehicles 14.) Although not shown in the drawing, additional human occupants 13 may be present inside or outside the vehicle 10. (Note that as used herein, a “human occupant” does not have to be situated inside the vehicle 10 so as to “occupy” or be present within the interior 11 of the vehicle 10, but may also be outside the vehicle 10.) The subject vehicle 10 and the other vehicle(s) 14 are each configured so as to be capable of transporting one or more human occupants 13.

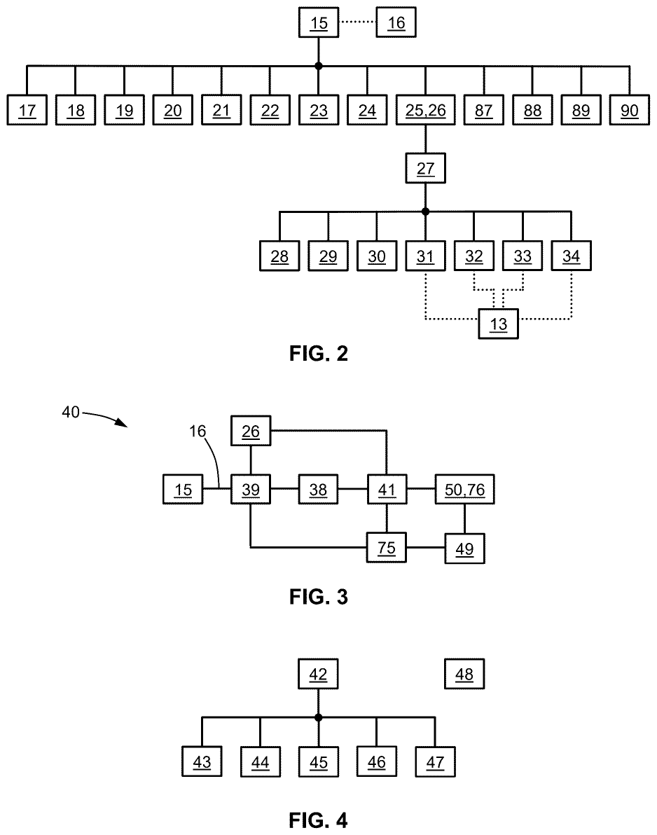

The subject vehicle 10 may have a variety of sensors 15 located within the interior 11 and/or on the exterior 12 which provide respective sensor outputs 16. FIG. 2 shows a block diagram of the various types of sensors 15 that may be associated with the vehicle 10. These may include an internal microphone 17 inside the automotive vehicle 10, an external microphone 18 outside the automotive vehicle 10, an internal camera 19 inside the automotive vehicle 10, an external camera 20 outside the automotive vehicle 10, a seat occupancy detector 21, a seatbelt payout detector 22, a PRNDL status detector 87, a door locked/unlocked status detector 88, an accessory mode on/off status detector 89, a key fob/key pass proximity detector 90, a temperature detector 23 outside the automotive vehicle 10, a weather sensor 24 outside the automotive vehicle 10 and a wireless receiver 25 or wireless transceiver 26 configured to receive transmitted information 27. (Note that as used herein, a “wireless receiver” 25 can include a wireless transceiver 26, since a wireless transceiver 26 has the ability to receive transmitted information 27.)

Each camera 19, 20 may be an imaging device capable of recording images and/or video in the visible light spectrum, the infrared light spectrum, the ultraviolet light spectrum and/or other electromagnetic spectra. The cameras 19, 20 may also include imaging and/or range-finding devices utilizing lasers (e.g., LiDAR, or light detection and ranging), ultrasound and the like.

The transmitted information 27 may be transmitted wirelessly from a variety of places (such as a weather service, a data warehouse, a call center, a service center, etc.), and may include information relating to one or more of a location 28 of the automotive vehicle 10, a current time of day 29, current or expected weather conditions 30 at the location 28 of the automotive vehicle 10, and a respective age 31, medical condition 32, mobility status 33 or biometric information 34 (including voice pattern or voice print) of one or more of the human occupants 13.

The information provided by these sensors 15 as sensor output 16 regarding the vehicle's environment (both on the interior 11 of the vehicle 10 and immediately outside the vehicle 10), as well as the personal information of the occupants 13 provided as transmitted information 27, may be utilized to proactively and automatically detect potential distress situations 49, to triage such situations 49 according to their type and severity, and to take appropriate action, as described in more detail below. For example, the logic used to detect, triage and respond to such situations 49 may benefit from knowing the age 31, medical condition 32 and mobility status 33 of the occupants 13 to help determine, for example, whether an occupant 13 is an infant or elderly, or has special medical or mobility needs, or the like. The logic used may also benefit from knowing the current or expected conditions at the location 28 of the vehicle 10 and its environment, such as the weather conditions 30, the outside temperature, and whether the location 28 of the vehicle 10 might be in a high crime neighborhood or in an otherwise potentially dangerous area.

Returning to FIG. 1, the human occupant 13 is shown carrying a key fob 35 (containing a wireless transmitter) or a digital device 36 (e.g., a smartphone, a smartwatch or smart glasses), each of which is capable of wirelessly transmitting a proximity signal 37 that may be sensed by a sensor 15 (such as a wireless receiver/transceiver 25, 26 or a key fob/key pass proximity detector 90). When the human occupant 13 is within a predetermined range from the vehicle 10, the sensor 15 will detect the proximity signal 37, thus letting various sub-systems within the vehicle 10 know that a human occupant 13 is near the vehicle 10. The proximity (i.e., nearness) of a human occupant 13 may also be detected by one or more sensors 15 other than a wireless receiver/transceiver 25, 26 or a key fob/key pass proximity detector 90, such as the human occupant 13 being imaged by a camera 19, 20 onboard the automotive vehicle 10, or by the human occupant 13 being sensed (i.e., heard) by a microphone 17, 18 onboard the automotive vehicle 10. (In the case of a camera 19, 20, a gait or walking pattern of an occupant 13 outside the vehicle 10 may also be detected, to determine whether the occupant 13 may be staggering, stumbling or otherwise having difficulty walking.) Once one of these sensors 15 detects the presence or proximity of a human occupant 13 outside and near the vehicle 10, one or more other sensors 15 onboard the automotive vehicle 10 (besides the one or more sensors 15 initially detecting the proximity of the human occupant 13) may be activated or “woken up” (i.e., powered up).

In addition to the one or more sensors 15 onboard the vehicle 10, the subject vehicle 10 also includes a wireless transceiver 26 and an access point 38, as well as a processor 39 operatively connected with the sensors 15, the wireless transceiver 26 and the access point 38. The access point 38 may be a device, a circuit or the like that is configured for providing the processor 39 with access to a large language model (LLM) 41. This LLM 41 may be carried onboard the vehicle 10—such as within the access point 38 itself, or in a memory connected with the processor 39 via the access point 38—or the LLM 41 may be stored offboard the vehicle 10 (such as in a data warehouse or in the cloud) and accessed via the access point 38 (in which case the access point 38 may take the form of or cooperate with the wireless transceiver 26). Note that in FIG. 1, both of these options for the LLM 41 are shown, with the schematic boxes and connecting lines for reference numeral 41 being shown using dotted lines to indicate that either or both of these options may be used.

FIG. 3 shows a block diagram of the system 40 shown in FIG. 1, with additional details added regarding the LLM 41 portion of the system 40. The LLM 41 is structured or configured for identifying potential distress situations 49, by being trained on a voluminous collection of previously recorded in-vehicle distress calls 50. Because of this training, the LLM 41 is able to determine patterns, associations and relationships among the words and sounds (and possibly other information as well, such as images, timestamps, sensor info or other data) that are recorded as part of each distress call 50.

For example, the LLM 41 may learn from being trained on the collection of distress calls 50 to determine when certain combinations or sequences of words, sounds and other recorded or detected data indicate that a potential or actual distress situation has occurred or is likely to occur. Furthermore, the LLM 41 may be trained on the collection of previously recorded in-vehicle distress calls 50 to distinguish among various types of potential distress situations 49, as described in more detail below. Additionally, the LLM 41 may be trained to recognize associations among the various types of potential (and actual) distress situations 49 observed, the types of responses or actions taken, and the ultimate outcomes 74 of taking the responses or actions. (Thus, the voluminous collection of previously recorded in-vehicle distress calls 50, along with any additional recorded in-vehicle distress calls 76 as discussed below, may collectively represent the “ground truth”—i.e., the actual historical reality—of the relationships, sequences and associations among the recorded data, the occurrence and type of potential distress situations 49, the actions taken, and the outcomes 74 achieved.)

Optionally, the LLM 41 may be configured as a compressed large language model, a small language model (SLM) or the like. Together, the one or more sensors 15, the wireless transceiver 26, the access point 38 and the LLM 41 make up a system 40 for emergent scenario detection during non-driving situations 42 in an automotive vehicle 10.

FIG. 4 shows a block diagram illustrating the various non-driving situations 42 in which the system 40 may be utilized. These situations 42 may include: (i) a human occupant 13 approaching (e.g., walking toward and/or standing near) the vehicle 10, as represented by reference numeral 43; (ii) ingressing (i.e., getting into or boarding) the vehicle 10, as represented by reference numeral 44; (iii) being seated within but not driving the vehicle 10 (optionally with the ignition on or off and the accessory mode on or off), as represented by reference numeral 45; (iv) egressing (i.e., getting out of) the vehicle 10, as represented by reference numeral 46; and (v) departing away from the vehicle 10 (e.g., after having been inside or standing near the vehicle 10), as represented by reference numeral 47. As illustrated by the diagram, these non-driving situations 42 may exclude driving situations 48 in which the vehicle 10 is in propulsion mode, and either a human occupant 13 is driving the vehicle 10 or the vehicle 10 is in a self-driving mode.

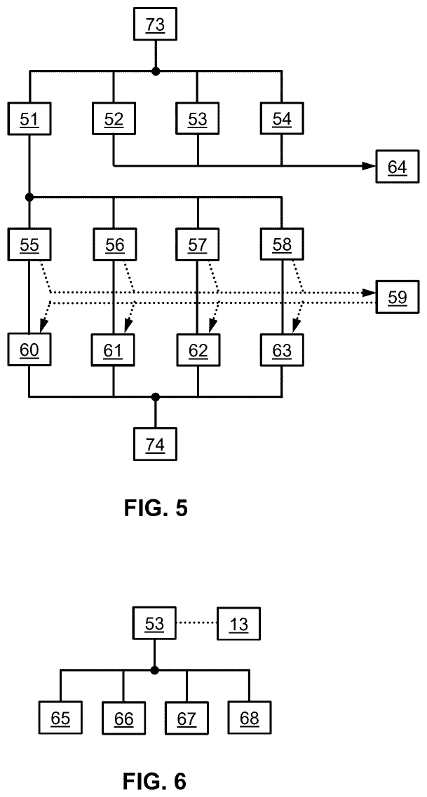

As noted above in connection with FIG. 3, and further considering the block diagram of FIG. 5, the system 40 includes: (i) one or more sensors 15 onboard the automotive vehicle 10; (ii) a wireless transceiver 26 onboard the automotive vehicle 10; (iii) an access point 38 for providing access to an LLM 41, wherein the LLM 41 is trained to identify (or assist in identifying) potential distress situations 49 based on a collection of previously recorded in-vehicle distress calls 50; and (iv) a processor 39 operatively connected with the one or more sensors 15, the wireless transceiver 26 and the access point 38. The processor 39 is configured for receiving sensor output 16 from the one or more sensors 15, detecting a potential distress situation 49 based on the sensor output 16 by accessing and using the LLM 41, and triaging the potential distress situation 49 as being one of an emergent situation 51 (i.e., an emergency or distress situation), a normal non-emergent situation 52, a good Samaritan situation 53 and a roadside assistance situation 54 by accessing and using the LLM 41. (Note that as used herein, “triaging” means evaluating, sorting, categorizing, prioritizing, designating and/or managing.)

As illustrated in FIG. 5, it may be seen that every emergent situation 51 is further triaged as being one or more of a health-related situation 55, a law enforcement-related situation 56, a fire-related situation 57 and a rescue-related situation 58 by accessing and using the LLM 41 to essentially compare the present inputs and conditions against the collection of previously recorded in-vehicle distress calls 50 (and against additional recorded in-vehicle distress calls 76, as discussed below).

Additionally, the processor 39 may be configured for use with the LLM 41 such that for an emergent situation 51, a live call center 59 may be contacted using the wireless transceiver 26, which is represented by the dotted lines in FIG. 5. Alternatively or additionally, the processor 39 may be configured for use with the LLM 41 such that for an emergent situation 51, a respective one or more of an emergency medical service 60, a law enforcement service 61, a firefighting service 62 and a rescue service 63 may be contacted by using the wireless transceiver 26, which is represented by the solid lines in FIG. 5 connecting the aforementioned situations 55, 56, 57, 58 with the aforementioned services 60, 61, 62, 63. In addition to contacting one or more of a live call center 59, an emergency medical service 60, a law enforcement service 61, a firefighting service 62 and a rescue service 63, the processor 39 may also be configured to contact a tow truck, a taxi service and/or other services.

Furthermore, the processor 39 may be configured for use with the LLM 41 such that for any normal non-emergent situation 52, good Samaritan situation 53 or roadside assistance situation 54—which is typically less of an emergency and less urgent than an emergent situation 51—the one or more human occupants 13 may be connected with an interactive digital assistant 64. The interactive digital assistant 64 may take the form of various hardware and/or software (including artificial intelligence) that is onboard the vehicle 10 which can interact with the occupants 13 and provide assistance, or it may take the form of hardware and/or software that is housed outside the vehicle 10 which the occupants 13 can interact with remotely via the wireless transceiver 26. This aspect of connecting the occupants 13 with an interactive digital assistant 64 in these situations 52, 53, 54—rather than connecting with a live call center 59—helps to reduce the call volume coming into the live call center 59, so that the live call center 59 may be more available to focus on any emergent situations 51 that arise.

FIG. 6 shows a block diagram illustrating various types of good Samaritan situations 53. These may include one or more human occupants 13 showing indications (e.g., by their words, tone of voice, facial expressions, hand gestures, etc.) that one or more of the occupants 13 is aware of a situation or condition that may present a potential or actual danger, threat or need for assistance, relating to a person 65 (e.g., a bystander or pedestrian), an animal 66 (e.g., a stray or injured pet, farm animal or wild animal), an item of infrastructure 67 (e.g., a stop light, a stop sign or a manhole cover), or an item of property 68 (e.g., another automotive vehicle 14), all of which are located outside the subject vehicle 10. The roadside assistance situation 54 may include one or more human occupants 13 showing awareness of a situation or condition which presents a potential or actual need for assistance relating to the subject automotive vehicle 10 (e.g., an occupant 13 saying “Look, there's smoke coming from under the hood” or “What's that noise the car is making?”). Note that either or both of the good Samaritan situation 53 and the roadside assistance situation 54 may include detection of a situation in which a tow truck, a taxi service or the like may be needed.

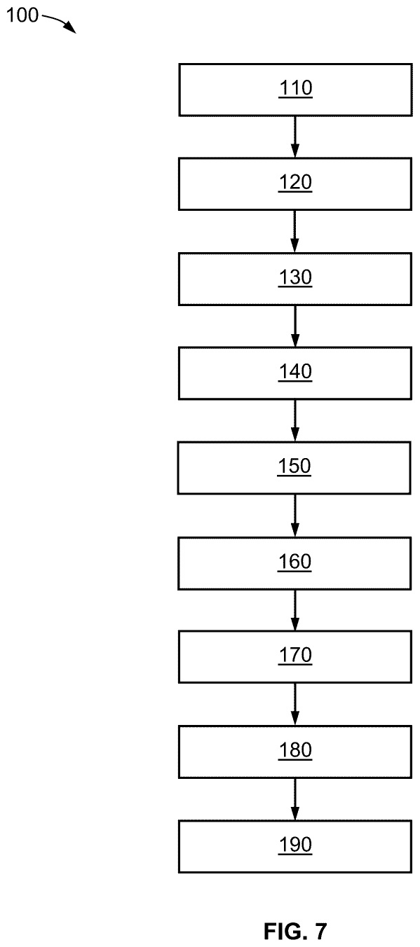

FIG. 7 shows a flowchart for a method 100 of emergent scenario detection during non-driving situations 42 in an automotive vehicle 10. The process flow of steps shown in the flowchart may be carried out by the abovementioned system 40.

As shown in the flowchart, at block 110, a proximity of one or more human occupants 13 to the vehicle 10 is detected by one or more of receiving a proximity signal 37 from a key fob 35 or a digital device 36, imaging the one or more human occupants 13 by using a camera 19, 20 onboard the vehicle 10, and sensing the one or more human occupants 13 by using a microphone 17, 18 onboard the vehicle 10. At block 120, one or more other sensors 15 onboard the vehicle 10 are activated (e.g., in response to the proximity signal 37). At block 130, sensor output 16 is received from one or more sensors 15 located onboard the vehicle 10. At block 140, a potential distress situation 49 is detected based on the sensor output 16 from the one or more sensors 15 by accessing and using an LLM 41, wherein the LLM 41 is trained to identify potential distress situations 49 based on a collection of previously recorded in-vehicle distress calls 50. At block 150, the potential distress situation 49 is triaged as being one of an emergent situation 51, a normal non-emergent situation 52, a good Samaritan situation 53 and a roadside assistance situation 54. At block 160, for any normal non-emergent situation 52, good Samaritan situation 53 or roadside assistance situation 54, the one or more human occupants 13 are connected with an interactive digital assistant 64. At block 170, for the emergent situation 51, the one or more human occupants 13 are connected with a live call center 59. At block 180, for the emergent situation 51, the emergent situation 51 is further triaged as being one or more of a health-related situation 55, a law enforcement-related situation 56, a fire-related situation 57 and a rescue-related situation 58. And at block 190, for the emergent situation 51, a respective one or more of an emergency medical service 60, a law enforcement service 61, a firefighting service 62 and a rescue service 63 is contacted.

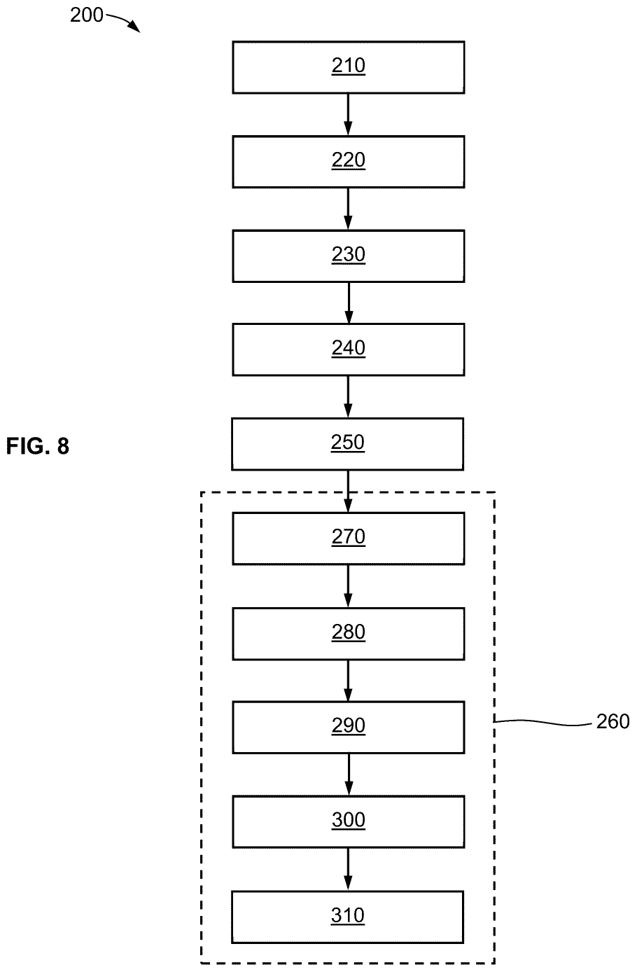

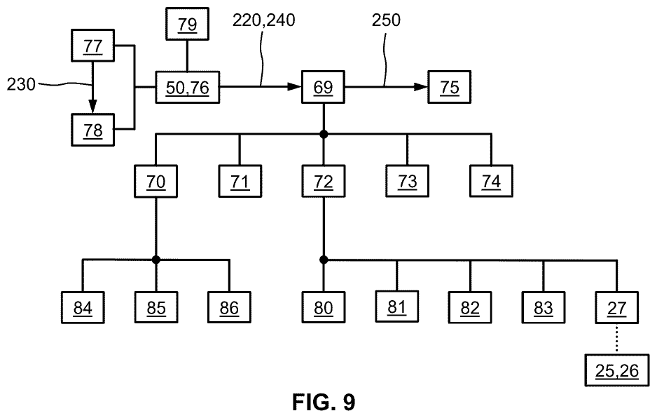

FIG. 8 shows a flowchart for a method 200 of training the LLM 41, and FIG. 9 shows a block diagram of various types of metadata 69 that may be present in the collections of distress calls 50, 76. At block 210, the collection of previously recorded in-vehicle distress calls 50 is accessed. These distress calls 50 may be recorded in one or both of an audio-based format 77 and a text-based format 78. At block 220, the distress calls 50 may optionally be filtered to exclude any driving situations 48, so that only non-driving situations 42 are considered. At block 230, any audio-based format 77 of the previously recorded in-vehicle distress calls 50 may optionally be converted into the text-based format 78. At block 240, metadata 69 is extracted from the distress calls 50 while ignoring any personally identifiable information 79 (including biometric information 34) that may be present in the distress calls 50.

As illustrated in FIG. 9, the metadata 69 may include one or more of audio data 70 (e.g., individual sound elements), text data 71, sensor data 72 collected by the subject vehicle 10 or by other automotive vehicles 14, a type of emergency 73 or situation related to the distress calls 50, 76, and an outcome 74 of the distress calls 50, 76.

At block 250, the various bits of metadata 69 are then correlated with each other (so as to identify patterns, associations and correlations among the bits of metadata 69) in order to produce a ruleset 75. For each of the distress calls 50, the ruleset 75 correlates one or more of the audio data 70, the text data 71 and the sensor data 72 with one or both of the type of emergency/situation 73 and the outcome 74. This ruleset 75 is not necessarily limited to direct correlations between the audio, text and sensor data 70, 71, 72 and the type of emergency/situation 73 and outcome 74, but may also include various associations and sequence orders among the bits of data, as well as frequency weightings, probability weightings and the like.

At block 260, the ruleset 75 may be updated by repeating the accessing, extracting and correlating steps of blocks 210, 240 and 250, respectively, but using a collection of additional recorded in-vehicle distress calls 76 in place of the collection of previously recorded in-vehicle distress calls 50. That is, the repeating step of block 260 may include: (i) at block 270, accessing the collection of additional distress calls 76; (ii) at block 280, filtering the additional distress calls 76 to exclude any driving situations 48; (iii) at block 290, converting any audio-based format 77 of the additional distress calls 76 into a text-based format 78; (iv) at block 300, extracting metadata 69 from the additional distress calls 76 while ignoring any personally identifiable information 79; and (v) at block 310, correlating the bits of metadata 69 associated with the additional distress calls 76 in order to further produce, expand, modify, fine-tune and/or update the ruleset 75.

As shown in FIG. 9, the sensor data 72 from the various sensors 15 may include detection data 80 (e.g., indicating the presence of an occupant 13 or object), numerical measurement data 81, image data 82 or video data 83 received from one or more sensors 15 that are onboard the subject vehicle 10 or another vehicle 14, and transmitted information 27 received by a wireless receiver/transceiver 25, 26 onboard the subject vehicle 10 or other vehicles 14.

The audio data 70 may include one or more of verbal speech sounds 84 (e.g., of individual words spoken by an occupant 13), non-verbal speech sounds 85 (e.g., non-word sounds or exclamations uttered by an occupant 13, including screams, laughs, moans, etc.), and non-speech sounds 86 (e.g., sounds made by the vehicle 10, 14 or by other sources outside the vehicle 10, 14, such as traffic noises, sirens, etc.). Additionally, the audio and text data 70, 71 may include “hybrid” words or phrases spoken by an occupant 13 who speaks two or more languages; sources of such hybrid words or phrases may include so-called “Spanglish” (a mixture of Spanish and English), “Hinglish” (a mixture of Hindi and English) , and the like.

As discussed above and as illustrated in FIG. 5, the type of emergency 73 may include one or more of an emergent situation 51, a normal non-emergent situation 52, a good Samaritan situation 53 and a roadside assistance situation 54. For the emergent situation 51, the type of emergency 73 may further include one or more of a health-related situation 55, a law enforcement-related situation 56, a fire-related situation 57 and a rescue-related situation 58, and the outcome 74 may include connecting the one or more human occupants 13 with one or more of a live call center 59, an emergency medical service 60, a law enforcement service 61, a firefighting service 62 and a rescue service 63.

As one having skill in the relevant art will appreciate, the system 40 and methods 100, 200 of the present disclosure may be presented or arranged in a variety of different configurations and embodiments.

According to one embodiment, a method 100 of emergent scenario detection during non-driving situations 42 in an automotive vehicle 10 that is capable of transporting one or more human occupants 13 includes: (i) receiving sensor output 16 from one or more sensors 15 located onboard the automotive vehicle 10; (ii) detecting a potential distress situation 49 based on the sensor output 16 by using a large language model (LLM) 41, wherein the LLM 41 is trained to identify potential distress situations 49 based on a collection of previously recorded in-vehicle distress calls 50; (iii) triaging the potential distress situation 49 as being one of an emergent situation 51, a normal non-emergent situation 52, a good Samaritan situation 53 and a roadside assistance situation 54; (iv) for the emergent situation 51, further triaging the emergent situation 51 as being one or more of a health-related situation 55, a law enforcement-related situation 56, a fire-related situation 57 and a rescue-related situation 58; and (v) for the emergent situation 51, contacting a respective one or more of an emergency medical service 60, a law enforcement service 61, a firefighting service 62 and a rescue service 63.

The non-driving situations 42 may include the one or more human occupants 13 engaging in one or more of approaching the automotive vehicle 10, ingressing the automotive vehicle 10, being seated within but not driving the automotive vehicle 10, egressing the automotive vehicle 10, and departing away from the automotive vehicle 10.

For the emergent situation 51, the method 100 may further include connecting the one or more human occupants 13 with a live call center 59; for any of the normal non-emergent situation 52, the good Samaritan situation 53 and the roadside assistance situation 54, the method 100 may further include connecting the one or more human occupants 13 with an interactive digital assistant 64.

The good Samaritan situation 53 may include the one or more human occupants 13 showing awareness of a situation or condition which presents a potential or actual need for assistance relating to a person 65, an animal 66, an infrastructure 67 or a property 68 located outside the automotive vehicle 10.

The roadside assistance situation 54 may include the one or more human occupants 13 showing awareness of a situation or condition which presents a potential or actual need for assistance relating to the automotive vehicle 10.

The one or more sensors 15 may include one or more of an internal microphone 17 inside the automotive vehicle 10, an external microphone 18 outside the automotive vehicle 10, an internal camera 19 inside the automotive vehicle 10, an external camera 20 outside the automotive vehicle 10, a seat occupancy detector 21, a seatbelt payout detector 22, a PRNDL status detector 87, a door locked/unlocked status detector 88, an accessory mode on/off status detector 89, a key fob/key pass proximity detector 90, a temperature detector 23 outside the automotive vehicle 10, a weather sensor 24 outside the automotive vehicle 10 and a wireless receiver 25 of transmitted information 27. The transmitted information 27 may include information relating to one or more of a location 28 of the automotive vehicle 10, a current time of day 29, current or expected weather conditions 30 at the location 28 of the automotive vehicle 10, and a respective age 31, medical condition 32, mobility status 33 or biometric information 34 of one or more of the human occupants 13.

The method 100 may further include one or more of: (i) detecting a proximity of the one or more human occupants 13 to the automotive vehicle 10 by one or more of receiving a proximity signal 37 from a key fob 35 or a digital device 36, imaging the one or more human occupants 13 by using a camera 19, 20 onboard the automotive vehicle 10, and sensing the one or more human occupants 13 by using a microphone 17, 18 onboard the automotive vehicle 10; and (ii) activating one or more other sensors 15 onboard the automotive vehicle 10.

The LLM 41 may be trained to identify the potential distress situations 49 by: (a) extracting metadata 69 from the collection of previously recorded in-vehicle distress calls 50 while ignoring personally identifiable information 79 from the distress calls 50, wherein the metadata 69 include one or more of audio data 70, text data 71, sensor data 72 collected by the automotive vehicle 10 or by other automotive vehicles 14, a type of emergency 73 related to the distress call 50, and an outcome 74 of the distress call 50; (b) correlating the metadata 69 to produce a ruleset 75, wherein for each of the distress call 50 the ruleset 75 correlates one or more of the audio data 70, the text data 71 and the sensor data 72 with one or both of the type of emergency 73 and the outcome 74; and (c) updating the ruleset 75 by repeating the accessing, extracting and correlating steps using additional recorded in-vehicle distress calls 76.

One or both of the triaging and the further triaging may be performed by using the LLM 41.

According to another embodiment, a method 200 of training a large language model 41 for use in emergent scenario detection during non-driving situations 42 in an automotive vehicle 10 that is capable of transporting one or more human occupants 13 includes: (i) accessing a collection of previously recorded in-vehicle distress calls 50; (ii) extracting metadata 69 from the distress calls 50 while ignoring personally identifiable information 79 from the distress calls 50, wherein the metadata 69 include one or more of audio data 70, text data 71, sensor data 72 collected by the automotive vehicle 10 or by other automotive vehicles 14, a type of emergency 73 related to the distress calls 50, and an outcome 74 of the distress calls 50; (iii) correlating the metadata 69 to produce a ruleset 75, wherein for each of the distress calls 50 the ruleset 75 correlates one or more of the audio data 70, the text data 71 and the sensor data 72 with one or both of the type of emergency 73 and the outcome 74; and (iv) updating the ruleset 75 by repeating the accessing, extracting and correlating steps using additional recorded in-vehicle distress calls 76.

The method 200 may further include filtering the previously recorded in-vehicle distress calls 50 and the additional recorded in-vehicle distress calls 76 to exclude any driving situations 48.

The previously recorded in-vehicle distress calls 50 and the additional recorded in-vehicle distress calls 76 may be recorded in one or both of an audio-based format 77 and a text-based format 78. The method 200 may further include converting any audio-based format 77 of the previously recorded in-vehicle distress calls 50 and the additional recorded in-vehicle distress calls 76 into the text-based format 78.

The personally identifiable information 79 may include biometric information 34.

The sensor data 72 may include one or more of: (i) detection data 80, measurement data 81, image data 82 or video data 83 received from one or more sensors 15 that are onboard the automotive vehicle 10; and (ii) transmitted information 27 received from a wireless receiver 25 onboard the automotive vehicle 10.

The audio data 70 may include one or more of verbal speech sounds 84, non-verbal speech sounds 85 and non-speech sounds 86.

The type of emergency 73 may include one or more of an emergent situation 51, a normal non-emergent situation 52, a good Samaritan situation 53 and a roadside assistance situation 54. For the emergent situation 51, the type of emergency 73 may further include one or more of a health-related situation 55, a law enforcement-related situation 56, a fire-related situation 57 and a rescue-related situation 58, and the outcome 74 may include connecting the one or more human occupants 13 with one or more of a live call center 59, an emergency medical service 60, a law enforcement service 61, a firefighting service 62 and a rescue service 63.

According to yet another embodiment, a system 40 for emergent scenario detection during non-driving situations 42 in an automotive vehicle 10 that is capable of transporting one or more human occupants 13 includes: (i) one or more sensors 15 onboard the automotive vehicle 10; (ii) a wireless transceiver 26 onboard the automotive vehicle 10; (iii) an access point 38 for providing access to a large language model (LLM) 41, wherein the LLM 41 is trained to identify potential distress situations 49 based on a collection of previously recorded in-vehicle distress calls 50; and (iv) a processor 39 operatively connected with the one or more sensors 15, the wireless transceiver 26 and the access point 38. The processor 39 is configured for: (a) receiving sensor output 16 from the one or more sensors 15; (b) detecting a potential distress situation 49 based on the sensor output 16 by using the LLM 41; (c) triaging the potential distress situation 49 as being one of an emergent situation 51, a normal non-emergent situation 52, a good Samaritan situation 53 and a roadside assistance situation 54 by using the LLM 41; (d) for the emergent situation 51, further triaging the emergent situation 51 as being one or more of a health-related situation 55, a law enforcement-related situation 56, a fire-related situation 57 and a rescue-related situation 58 by using the LLM 41; (e) for the emergent situation 51, contacting a live call center 59 or a respective one or more of an emergency medical service 60, a law enforcement service 61, a firefighting service 62 and a rescue service 63 by using the wireless transceiver 26; and (f) for any of the normal non-emergent situation 52, the good Samaritan situation 53 and the roadside assistance situation 54, connecting the one or more human occupants 13 with an interactive digital assistant 64.

While various steps of the methods 100, 200 have been described as being separate blocks, and various functions of the system 40 have been described as being separate modules or elements, it may be noted that two or more steps may be combined into fewer blocks, and two or more functions may be combined into fewer modules or elements. Similarly, some steps described as a single block may be separated into two or more blocks, and some functions described as a single module or element may be separated into two or more modules or elements. Additionally, the order of the steps or blocks described herein may be rearranged in one or more different orders, and the arrangement of the functions, modules and elements may be rearranged into one or more different arrangements.

(As used herein, a “module” may include hardware and/or software, including executable instructions, for receiving one or more inputs, processing the one or more inputs, and providing one or more corresponding outputs. Also note that at some points throughout the present disclosure, reference may be made to a singular input, output, element, etc., while at other points reference may be made to plural/multiple inputs, outputs, elements, etc. Thus, weight should not be given to whether the input(s), output(s), element(s), etc. are used in the singular or plural form at any particular point in the present disclosure, as the singular and plural uses of such words should be viewed as being interchangeable, unless the specific context dictates otherwise.)

The above description is intended to be illustrative, and not restrictive. While the dimensions and types of materials described herein are intended to be illustrative, they are by no means limiting and are exemplary embodiments. In the following claims, use of the terms “first”, “second”, “top”, “bottom”, etc. are used merely as labels, and are not intended to impose numerical or positional requirements on their objects. As used herein, an element or step recited in the singular and preceded by the word “a” or “an” should be understood as not excluding plural of such elements or steps, unless such exclusion is explicitly stated. Additionally, the phrase “at least one of A and B” and the phrase “A and/or B” should each be understood to mean “only A, only B, or both A and B”. Moreover, unless explicitly stated to the contrary, embodiments “comprising” or “having” an element or a plurality of elements having a particular property may include additional such elements not having that property. And when broadly descriptive adverbs such as “substantially” and “generally” are used herein to modify an adjective, these adverbs mean “mostly”, “mainly”, “for the most part”, “to a significant extent”, “to a large degree” and/or “at least 51 to 99% out of a possible extent of 100%”, and do not necessarily mean “perfectly”, “completely”, “strictly”, “entirely” or “100%”. Additionally, the word “proximate” may be used herein to describe the location of an object or portion thereof with respect to another object or portion thereof, and/or to describe the positional relationship of two objects or their respective portions thereof with respect to each other, and may mean “near”, “adjacent”, “close to”, “close by”, “at” or the like.

This written description uses examples, including the best mode, to enable those skilled in the art to make and use devices, systems and compositions of matter, and to perform methods, according to this disclosure. It is the following claims, including equivalents, which define the scope of the present disclosure.

What is claimed is:

1. A method of emergent scenario detection during non-driving situations in an automotive vehicle that is capable of transporting one or more human occupants, comprising:
receiving sensor output from one or more sensors located onboard the automotive vehicle;
detecting a potential distress situation based on the sensor output by using a large language model (LLM), wherein the LLM is trained to identify potential distress situations based on a collection of previously recorded in-vehicle distress calls;
triaging the potential distress situation as being one of an emergent situation, a normal non-emergent situation, a good Samaritan situation and a roadside assistance situation;
for the emergent situation, further triaging the emergent situation as being one or more of a health-related situation, a law enforcement situation, a fire situation and a rescue situation; and
for the emergent situation, contacting a respective one or more of an emergency medical service, a law enforcement service, a firefighting service and a rescue service.

2. The method of claim 1, wherein the non-driving situations include the one or more human occupants engaging in one or more of:
approaching the automotive vehicle;
ingressing the automotive vehicle;
being seated within but not driving the automotive vehicle;
egressing the automotive vehicle; and
departing away from the automotive vehicle.

3. The method of claim 1, further comprising:
for the emergent situation, connecting the one or more human occupants with a live call center; and
for any of the normal non-emergent situation, the good Samaritan situation and the roadside assistance situation, connecting the one or more human occupants with an interactive digital assistant.

4. The method of claim 1, wherein the good Samaritan situation includes the one or more human occupants showing awareness of a situation or condition which presents a potential or actual need for assistance relating to a person, an animal, an infrastructure or a property located outside the automotive vehicle.

5. The method of claim 1, wherein the roadside assistance situation includes the one or more human occupants showing awareness of a situation or condition which presents a potential or actual need for assistance relating to the automotive vehicle.

6. The method of claim 1, wherein the one or more sensors include one or more of an internal microphone inside the automotive vehicle, an external microphone outside the automotive vehicle, an internal camera inside the automotive vehicle, an external camera outside the automotive vehicle, a seat occupancy detector, a seatbelt payout detector, a PRNDL status detector, a door locked/unlocked status detector, an accessory mode on/off status detector, a key fob/key pass proximity detector, a temperature detector outside the automotive vehicle, a weather sensor outside the automotive vehicle and a wireless receiver of transmitted information.

7. The method of claim 6, wherein the transmitted information includes information relating to one or more of a location of the automotive vehicle, a current time of day, current or expected weather conditions at the location of the automotive vehicle, and a respective age, medical condition, mobility status or biometric information of one or more of the human occupants.

8. The method of claim 1, further comprising one or more of:
detecting a proximity of the one or more human occupants to the automotive vehicle by one or more of receiving a proximity signal from a key fob or a digital device, imaging the one or more human occupants by using a camera onboard the automotive vehicle, and sensing the one or more human occupants by using a microphone onboard the automotive vehicle; and
activating one or more other sensors onboard the automotive vehicle.

9. The method of claim 1, wherein the LLM is trained to identify the potential distress situations by:
extracting metadata from the collection of previously recorded in-vehicle distress calls while ignoring personally identifiable information from the distress calls, wherein the metadata include one or more of audio data, text data, sensor data collected by the automotive vehicle or by other automotive vehicles, a type of emergency related to the distress call, and an outcome of the distress call;
correlating the metadata to produce a ruleset, wherein for each of the distress calls the ruleset correlates one or more of the audio data, the text data and the sensor data with one or both of the type of emergency and the outcome; and
updating the ruleset by repeating the accessing, extracting and correlating steps using additional recorded in-vehicle distress calls.

10. The method of claim 1, wherein one or both of the triaging and the further triaging is performed by using the LLM.

11. A method of training a large language model for use in emergent scenario detection during non-driving situations in an automotive vehicle that is capable of transporting one or more human occupants, comprising:
accessing a collection of previously recorded in-vehicle distress calls;
extracting metadata from the distress calls while ignoring personally identifiable information from the distress calls, wherein the metadata include one or more of audio data, text data, sensor data collected by the automotive vehicle or by other automotive vehicles, a type of emergency related to the distress call, and an outcome of the distress call;
correlating the metadata to produce a ruleset, wherein for each of the distress calls the ruleset correlates one or more of the audio data, the text data and the sensor data with one or both of the type of emergency and the outcome; and
updating the ruleset by repeating the accessing, extracting and correlating steps using additional recorded in-vehicle distress calls.

12. The method of claim 11, further comprising:
filtering the previously recorded in-vehicle distress calls and the additional recorded in-vehicle distress calls to exclude any driving situations.

13. The method of claim 11, wherein the previously recorded in-vehicle distress calls and the additional recorded in-vehicle distress calls are recorded in one or both of an audio-based format and a text-based format.

14. The method of claim 13, further comprising:
converting any audio-based format of the previously recorded in-vehicle distress calls and the additional recorded in-vehicle distress calls into the text-based format.

15. The method of claim 11, wherein the personally identifiable information includes biometric information.

16. The method of claim 11, wherein the sensor data includes one or more of:
detection data, measurement data, image data or video data received from one or more sensors that are onboard the automotive vehicle; and
transmitted information received from a wireless receiver onboard the automotive vehicle.

17. The method of claim 11, wherein the audio data includes one or more of verbal speech sounds, non-verbal speech sounds and non-speech sounds.

18. The method of claim 11, wherein the type of emergency includes one or more of an emergent situation, a normal non-emergent situation, a good Samaritan situation and a roadside assistance situation.

19. The method of claim 18, wherein for the emergent situation, the type of emergency further includes one or more of a health-related situation, a law enforcement situation, a fire situation and a rescue situation, and the outcome includes connecting the one or more human occupants with one or more of a live call center, an emergency medical service, a law enforcement service, a firefighting service and a rescue service.

20. A system for emergent scenario detection during non-driving situations in an automotive vehicle that is capable of transporting one or more human occupants, comprising:
one or more sensors onboard the automotive vehicle;
a wireless transceiver onboard the automotive vehicle;
an access point for providing access to a large language model (LLM), wherein the LLM is trained to identify potential distress situations based on a collection of previously recorded in-vehicle distress calls; and
a processor operatively connected with the one or more sensors, the wireless transceiver and the access point, wherein the processor is configured for:
receiving sensor output from the one or more sensors;
detecting a potential distress situation based on the sensor output by using the LLM;
triaging the potential distress situation as being one of an emergent situation, a normal non-emergent situation, a good Samaritan situation and a roadside assistance situation by using the LLM;
for the emergent situation, further triaging the emergent situation as being one or more of a health-related situation, a law enforcement situation, a fire situation and a rescue situation by using the LLM;
for the emergent situation, contacting a live call center or a respective one or more of an emergency medical service, a law enforcement service, a firefighting service and a rescue service by using the wireless transceiver; and
for any of the normal non-emergent situation, the good Samaritan situation and the roadside assistance situation, connecting the one or more human occupants with an interactive digital assistant.
